(19) United States
(12) Patent Application Publication
(10) Pub. No.: US 2016/0184682 A1
(43) Pub. Date: Jun. 30, 2016

(54) METHOD FOR MAKING CLUB GRIP SLEEVE

(71) Applicant: HIGH CEDAR ENTERPRISE CO., LTD., Taichung (TW)

(72) Inventor: Yung-Han WANG, Taichung City (TW)

(21) Appl. No.: 14/722,583

(22) Filed: May 27, 2015

(30) Foreign Application Priority Data
Dec. 31, 2014 (TW) 103146511

(51) Int. Cl. A63B 60/14; A63B 53/14; B32B 37/10; B32B 37/14; B32B 37/12; B32B 37/06

(52) U.S. Cl. CPC A63B 60/14; B32B 37/12; B32B 37/06; B32B 37/10; B32B 37/14; A63B 53/14; B32B 2375/00

(57) ABSTRACT

A method for making a club grip sleeve involves affixing a composite adhesive layer that includes a double-sided adhesive tape and hot glue onto an elastic tube, mounting a finish tube around the elastic tube, and applying heat and pressure to the assembled grip sleeve so that the hot glue is melted and adheres to the finish tube.

### BACKGROUND OF THE INVENTION

1. Technical Field

The present invention relates to grip sleeves of clubs, and more particularly to a method for making a club grip sleeve.

2. Description of Related Art

Presently, a typical club grip sleeve, such as shown in FIG. 1 and FIG. 2, which is a grip sleeve (1) for a golf club (not shown), is composed of an elastic tube (2) and a finish layer (3), wherein the layers are combined by either double-sided adhesive tape or power adhesive.

Where double-sided adhesive tape is used, the double-sided adhesive tape has one side attached to the outer periphery of the elastic tube (2), and the tubular finish layer (3) is mounted around the elastic tube (2). Afterward, the release paper is removed from the double-sided adhesive tape so that the double-sided adhesive tape is adhered to the inner periphery of the finish layer, thereby fixing the finish layer (3) and the elastic tube (2) together. While this approach is effective in binding the elastic tube and the finish layer, removing the release paper is a challenging process.

In the alternative approach that uses power adhesive, power adhesive is applied to the outer periphery of the elastic tube (2), and then the finish layer (3) is mounted therearound for fixation. However, this approach has its problem that the stickiness of the power adhesive makes mounting the finish layer (3) very difficult. Additionally, for ensuring that the seam, stitches or graphic on the finish layer are positioned on a certain site around the grip sleeve, the tubular finish layer has to be aligned with some particular marks while combining with the elastic tube. Also, the stickiness of the power adhesive adds difficulty to the rotational adjustment ore realignment of the finish layer. Besides, since the power adhesive contains solvent, it is considered harmful to the environment and human health.

### SUMMARY OF THE INVENTION

In view of the shortcomings of the prior art, the objective of the present invention is to provide a method for making a club grip sleeve.

For achieving the foregoing objective, the disclosed method is developed based on the characteristic of hot glue that is not sticky when being cool and is sticky when being heated. The method involves setting hot glue on double-sided adhesive tape to form a composite adhesive layer, attaching the composite adhesive layer to an elastic tube, mounting a finish tube around the elastic tube, and applying heat and pressure to form the desired club grip sleeve.

### BRIEF DESCRIPTION OF THE DRAWINGS

FIG. 1 is an exploded view of a conventional club grip sleeve.

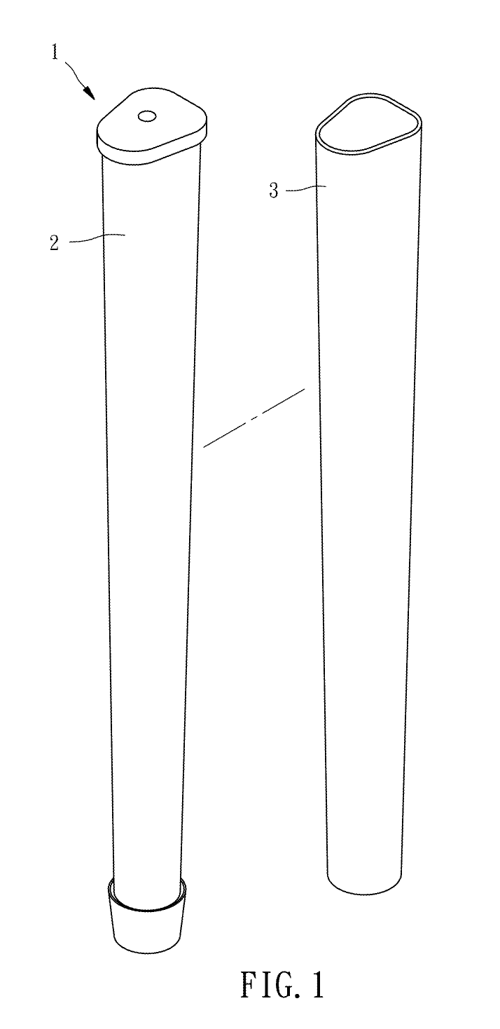

FIG. 2 is a cross-sectional view of the conventional club grip sleeve.

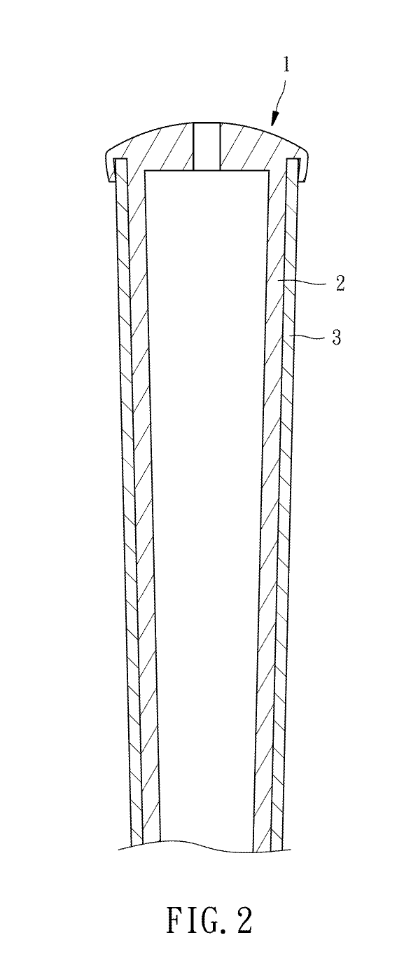

FIG. 3 is a flowchart of a method disclosed in the present invention.

FIG. 4 is an exploded view of a club grip sleeve making according to the present invention.

FIG. 5 is a cross-sectional view of the club grip sleeve according to the present invention.

### DETAILED DESCRIPTION OF THE INVENTION

The following description, in conjunction with the accompanying drawings and preferred embodiments, is set forth as below to illustrate the disclosed method for making a club grip sleeve.

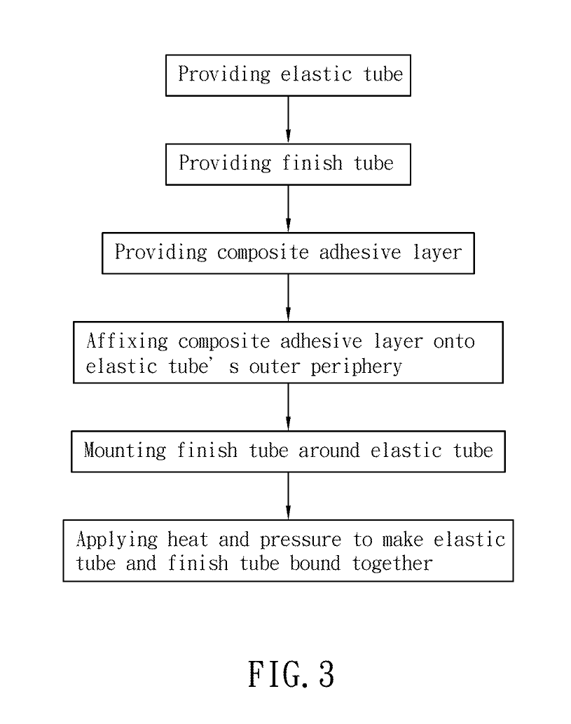

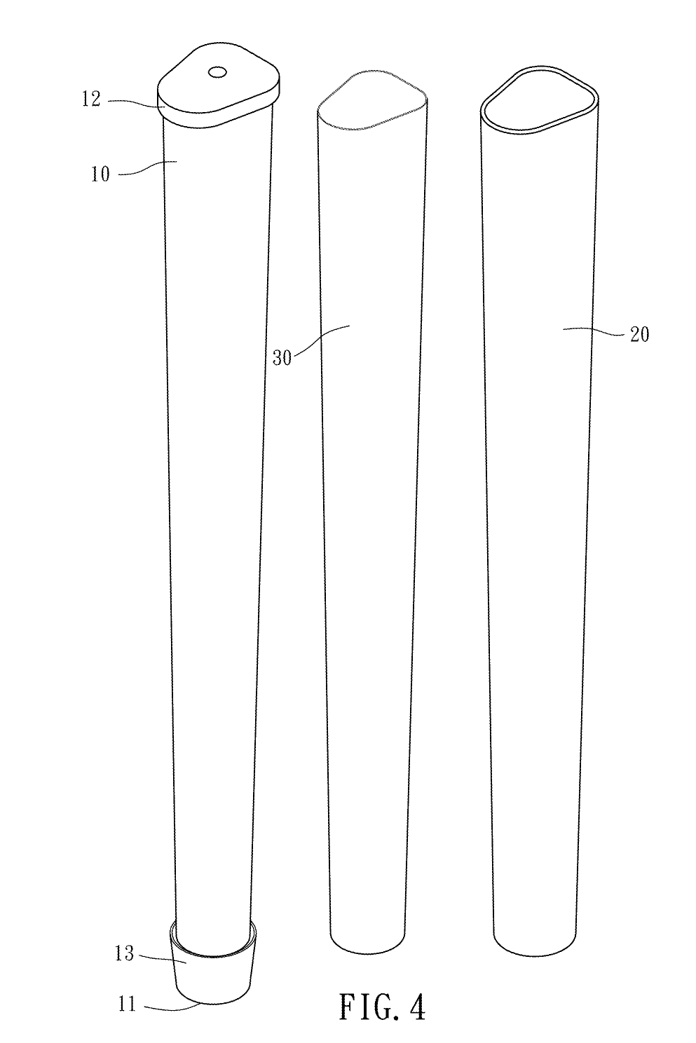

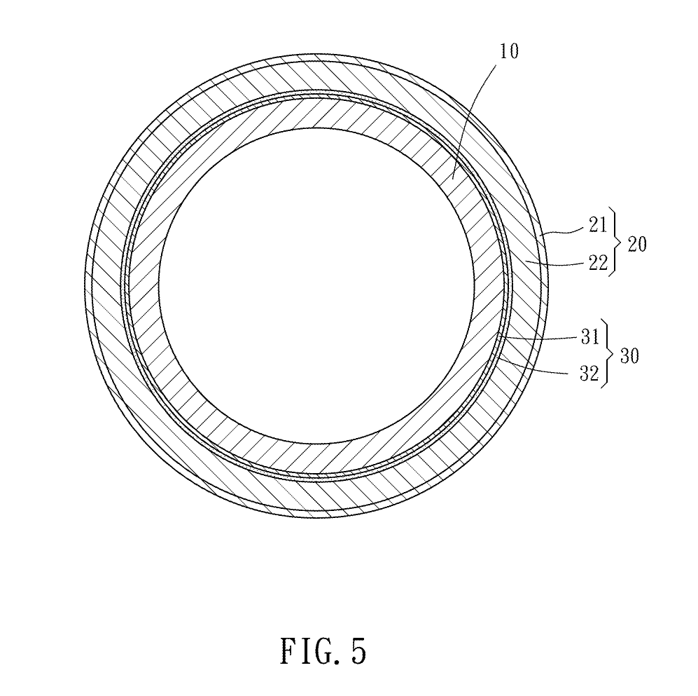

Referring to FIG. 3 through FIG. 5, the method of the present invention comprising the following steps:

providing an elastic tube (10) that has a lengthwise shape and has one end formed with an opening (11) so that the elastic tube (10) can be mounted around a club through the opening (11);

providing a finish tube (20) that is composed of a polyurethane layer (21) and a felt layer (22), wherein the felt layer (22) is the inner layer of the finish tube (20), and the polyurethane layer (21) is the outer layer of the finish tube (20);

providing a composite adhesive layer (30) that is composed of a double-sided adhesive tape layer (31) and a hot glue layer (32), wherein the hot glue layer (32) is applied to one side of the double-sided adhesive tape layer (31);

affixing the composite adhesive layer (30) to the outer periphery of the elastic tube (10) so that the hot glue layer (32) of the composite adhesive layer (30) is exposed outside;

mounting the finish tube (20) around the elastic tube (10), so that the composite adhesive layer (30) is located between the elastic tube (10) and the finish tube (20), and the hot glue layer (32) is next to the inner layer of the finish tube; and

applying heat and pressure to the club grip sleeve, so that the hot glue layer (32) is melted and adheres to the finish tube (20), thereby binding the elastic tube (10) and the finish tube (20) together.

In the disclosed method, the elastic tube (10) may be a simple tube with one end closed and the other end formed with the opening (11) for its assembly with a club. Alternatively, the elastic tube (10) may have its one end provided with an end cap (12), and the other end having the opening (11) is peripherally formed with an annular flange (13), so that the finish tube (20) when mounted around the elastic tube (10) is located between the end cap (12) and the annular flange (13).

The finish tube (20) may be an integratedly formed tubular body or made by rolling up a material sheet and jointing its two edges drawn close through adhesive or sewing. The material sheet is made by stacking a felt layer (22) onto a polyurethane layer (21).

The composite adhesive layer (30) may be made by applying a hot glue layer (32) on a double-sided adhesive tape layer (31), or made by affixing a hot glue film (32) onto a double-sided adhesive tape layer (31). The hot glue layer (32) may be applied to the entire surface of the side of the double-sided adhesive tape layer (31) or may partially cover the double-sided adhesive tape layer (31). Where the hot glue film is used, it may partially or entirely cover the entire side of the double-sided adhesive tape layer (31).

Since the hot glue layer is not sticky until it is properly heated, the operation of installing the finish tube is much easier and faster than that conducted in the prior art. In other words, the finish tube can be mounted without the interference of the stickiness of the glue. Also, the subsequent adjustment and realignment of the finish tube can be easily conducted without the interference of the stickiness of the glue. Additionally, the hot glue used in the disclosed method requires no solvent therein, so is safe to human health and the environment. Thereby, the present invention significantly improves the prior art and enhances the productivity of club grip sleeves.

What is claimed is:

1. A method for making a club grip sleeve, comprising the following steps:
providing an elastic tube that has a lengthwise shape;
providing a finish tube that includes a polyurethane layer and a felt layer, wherein the finish tube has the felt layer as an inner layer thereof and has the polyurethane layer as an outer layer thereof;
providing a composite adhesive layer that includes a double-sided adhesive tape layer and a hot glue layer stacked together;
affixing the composite adhesive layer onto an outer periphery of the elastic tube;
mounting the finish tube around the elastic tube, so that the composite adhesive layer is located between the elastic tube and the finish tube, and the hot glue layer is next to the inner layer of the finish tube; and
applying heat and pressure to the club grip sleeve such assembled, so that the hot glue layer is melted and adheres to the finish tube.

2. The method of claim 1, wherein the finish tube is made by rolling up a material sheet and jointing two edges of the rolled material sheet.

3. The method of claim 1, wherein the composite adhesive layer is made by applying a layer of hot glue to the double-sided adhesive tape layer.

4. The method of claim 3, wherein the hot glue is applied to the double-sided adhesive tape layer entirely.

5. The method of claim 3, wherein the hot glue layer is applied to the double-sided adhesive tape layer partially.

6. The method of claim 1, wherein the composite adhesive layer is made by affixing a hot glue film onto the double-sided adhesive tape layer.

7. The method of claim 6, wherein the hot glue film covers the double-sided adhesive tape layer entirely.

8. The method of claim 6, wherein the hot glue film covers the double-sided adhesive tape layer partially.

9. The method of claim 2, wherein the finish tube is made by rolling up a material sheet and jointing two edges of the rolled material sheet.

10. The method of claim 6, wherein the finish tube is made by rolling up a material sheet and jointing two edges of the rolled material sheet.
